(19) United States
(12) Patent Application Publication
(10) Pub. No.: US 2026/0145762 A1
(43) Pub. Date: May 28, 2026

(54) STEERING ASSISTANCE DEVICE FOR A VEHICLE

(71) Applicant: KTM AG, Mattighofen (AT)

(72) Inventor: Hannes FELLNER, Zipf (AT)

(21) Appl. No.: 19/451,732

(22) Filed: Jan. 16, 2026

Related U.S. Application Data
(63) Continuation of application No. PCT/AT2024/060274, filed on Jul. 15, 2024.

(30) Foreign Application Priority Data
Jul. 20, 2023 (AT) A 50583/2023

(51) Int. Cl. B62K 21/10; B62K 21/04

(52) U.S. Cl. CPC B62K 21/10; B62K 21/04

(57) ABSTRACT

A steering assistance device for a vehicle, in particular a single-track vehicle, includes a support element for mounting the steering assistance device on a frame or steering device of the vehicle, and a deflection device. The deflection device can be articulated to the steering device or the frame, and the deflection device is rotatably connected to the support element about an axis of rotation. The support element has at least one control cam, and the deflection device is connected to a follower element cooperating with the at least one control cam. The follower element is pre-tensioned relative to the at least one control cam by a tensioning element.

The present application is a continuation of International Application PCT/AT2024/060274 filed on Jul. 15, 2024. Thus, all of the subject matter of International Application PCT/AT2024/060274 is incorporated herein by reference.

### BACKGROUND OF THE INVENTION

The present invention relates to a steering assistance device for a vehicle and to a vehicle with a corresponding steering assistance device.

Vehicles, especially single-track vehicles, develop increasing driving stability at increasing speed. The prior art will be briefly outlined below using single-track vehicles as an example, but this generally applies to vehicles with steerable wheels. This phenomenon is due to the gyroscopic effect of the wheels, wherein increasing rotational speed of the wheels and the resulting gyroscopic moments and forces create certain inertias in the system, which give the single-track motor vehicle a certain stability in the direction of travel.

This stability is also reflected in the steering behavior of the single-track vehicle, in that, due to inertial forces, the steered wheel of the single-track vehicle tries to remain in its initial position and continue to guide the single-track vehicle straight ahead. To steer the single-track vehicle, it is therefore necessary to rotate the steered wheel around a steering axis by applying force, wherein however the acting forces always strive to return the steered wheel to its original position.

This phenomenon also increases with increasing rotational speed of the wheel and is not present when the wheel is stationary. Consequently, at very low speeds or when the single-track vehicle is stationary, a certain instability and tendency to tip over arises, which must be completely compensated for by balancing the single-track vehicle by the operator and/or driver.

These forces also occur as soon as the steered wheel of the single-track vehicle—usually the front wheel—leaves the ground and is thus lifted, resulting in a certain instability.

This leads to the desire for better driving dynamics, i.e. to be able to provide the appropriate forces for an operator and/or driver of the single-track vehicle even at low driving speeds; in particular, to be able to convert restoring torques to a handlebar of the single-track vehicle.

Furthermore, the steering head angle and the resulting caster angle sometimes have a strong influence on the steering behavior, because the caster angle creates a certain steering resistance that can be used to change the driving behavior for the operator and/or driver. Generally, driving stability increases with a higher caster angle.

Embodiments known from the prior art, such as those found in EP 4 101 751 A1, DE 10 2021 119189 A1, DE 10 2021 005463 A1 or DE 10 2021 006508 A1, comprise constructions made of spring elements which pre-tension a handlebar of a single-track vehicle in a central position. As soon as the handlebar is deflected from this central tension, the spring elements are further tensioned and a restoring torque to the central position is created.

A disadvantage of such systems, however, is that they exhibit a high degree of variability in adjustability, meaning that only highly trained specialists are able to make the desired settings, and this requires considerable effort, wherein it is also crucial that the settings for deflections in both directions are set in a synchronized manner, as otherwise the system will return to a position that differs from a central position (where the single-track vehicle travels straight ahead), thus posing a significant risk of accident for the operator and/or driver of the single-track vehicle.

Another problem with such a design is that these systems are quite complex, which is reflected not only in assembly and disassembly work, manufacturing work and setup times, but also in a lack of accessibility for an average operator and/or driver of the single-track vehicle.

Furthermore, such systems are not particularly robust against environmental influences, which means that spring elements already differ in their initial state, which is further exacerbated by different temperature influences, contamination and/or wear, thus showing an increased potential for a negative influence on the steering and therefore the risk of accidents with the single-track vehicle.

An alternative design is shown, for example, by DE 10 2021 123921 B2, which describes an actuator instead of spring elements, which is intended to build up a restoring torque on a handlebar of a single-track vehicle.

However, such a design is in turn associated with the risk of failure, wherein a failure of the electrical supply system or control system leads to an increased risk of accidents for the operator and/or driver of the single-track vehicle.

### SUMMARY OF THE INVENTION

The object of the present invention is therefore to provide a steering assistance device with which the aforementioned disadvantages of the prior art can be at least partially improved and/or the steering behavior of a vehicle can be improved and/or the ease of use of a vehicle can be increased and/or better driving behavior or improved feedback from the steering device, especially at low speeds during operation of the vehicle, can be offered to a driver and/or operator of the vehicle.

According to the invention, a steering assistance device for a vehicle comprises the following:
a support element for mounting the steering assistance device on a frame or steering device of the vehicle, and
a deflection device which deflection device can be articulated to the steering device or the frame, wherein the deflection device is rotatably connected to the support element about an axis of rotation.

The support element has at least one control cam and the deflection device is connected to a follower element cooperating with the control cam, wherein the follower element is pre-tensioned relative to the control cam by means of a tensioning element, preferably such that a torque is generated between the frame and the steering device depending on an angle of rotation.

By providing a control cam and a follower element that cooperates with the control cam, a simple way is created to individually adjust the steering behavior around the axis of rotation via the control cam, making it possible to set almost any steering behavior and/or restoring torque.

The functionality of a control cam and a cooperating follower element can be seen as a forced control element, which pursues the intended purpose independently of other control systems, thus preventing any failure risks or malfunctions, resulting in the highest possible safety for functionality for an operator and/or driver of the vehicle.

A control cam with a cooperating follower element also possesses very high stability, which is very well decoupled and/or virtually unaffected by influencing factors such as temperature, wear or contamination, so that no adjustment of the system itself occurs over time even due to wear.

Furthermore, the control cam and the follower element result in stable components which, after initial design and manufacturing, follow their intended use and cannot, for example, build up asymmetrical restoring torques through unintentional or accidental adjustment, thus not exposing an operator and/or driver of the vehicle to an increased risk of accidents.

In addition, a system according to the invention offers the advantage of a fairly compact design, which means that an embodiment according to the invention can also be accommodated in the small available installation space of a vehicle and does not represent too great an additional weight load for the vehicle.

A key aspect of the steering assistance device according to the invention is to provide a defined resistance torque (to maintain the steering angle) depending on the handlebar position (preferably all handlebar positions). Tests conducted by the applicant have shown that this defined resistance can provide the driver with a significantly improved driving experience when cornering.

An embodiment of a steering assistance device according to the invention can also be implemented and/or retrofitted, for example, in existing vehicles, in particular single-track vehicles,—as described, for example, in the introduction.

Vehicles according to the invention can be single-track or multi-track vehicles.

Vehicles can include, for example, single-track vehicles or motor vehicles such as motorcycles or bicycles (including pedelecs).

Single-track motor vehicles can include, for example, motorcycles, scooters, mopeds, mopeds or similar vehicles, which have electric drive units as well as combustion engines as drive units.

Multi-track vehicles, preferably multi-track motor vehicles, according to the invention can be, for example, so-called quads or trikes.

The vehicle according to the invention is particularly preferably a vehicle that is steered by means of a steering rod.

It is certainly conceivable to use embodiments in which the steering device carries the following element or the control cam. Accordingly, a steering movement always generates a movement of these two elements relative to each other (i.e., relative to one another).

According to the invention, the follower element is pre-tensioned relative to the at least one control cam. According to the invention, this applies to at least a certain range of steering angle positions, preferably all steering angle positions, optionally with the exception of a central position and/or maximum steering angles.

The preload according to the invention can therefore be present as a preload in all steering positions or at least in a certain range. Further steering movements can tighten the tensioning element, increase its tension, or reduce its preload, i.e., increase, maintain, or decrease the preload.

The at least one control cam is designed such that a distance between the control cam and the axis of rotation in a basic position, preferably a central position, represents an extremum, wherein when the deflection device is deflected relative to the support element from the basic position, the distance is changed, preferably wherein the tensioning element is pre-tensioned or further tensioned by the change in distance.

The tensioning element can accordingly be designed as a tension or compression element, preferably a tension or compression spring.

The at least one control cam is designed such that a distance between the control cam and the axis of rotation in a basic position, preferably a central position, represents a maximum, wherein when the deflection device is deflected relative to the support element from the basic position, the distance is reduced, preferably wherein the tensioning element is pre-tensioned or further tensioned by the reduction in distance.

Explanations where the extremum is a minimum and the change is a reduction would of course also be conceivable in principle.

Pre-tensioning the tensioning device by reducing the distance can be understood as additional and/or further tensioning of the tensioning device.

By reducing the distance and thus pre-tensioning or further tensioning the tensioning element, a restoring force to the basic position is achieved.

Preferably, the control cam can be designed symmetrically with respect to the deflection device in both directions of rotation of the support element, starting from the basic position.

Through appropriate design, it can be provided that the steering behavior, starting from a basic position, is designed to allow for both right and left steering positions with symmetrical steering characteristics and/or symmetrical steering assistance.

At least one control cam can define a steering characteristic. Preferably, the at least one control cam and/or the steering characteristic may have at least two gradients, preferably wherein the gradient is greater at small steering angles than at large steering angles. The steering characteristic can also be designed as a steering torque characteristic, for example.

The at least one gradient may be:
positive at small steering angles, and/or
positive, zero and/or negative at large steering angles.

The gradient can be determined relative to the steering angle with positive angles to the right from the perspective of the driver, or relative to the absolute value of the steering angle.

At least one control cam can be designed as an integral part of the support element or as a separate component connected to the support element.

Preferably, the tensioning element may have a power storage device, preferably comprising at least one spring element.

The support element can be connected to the steering device, preferably a steering fork, particularly preferably via a fork bridge, of the vehicle. For example, the support element can be attached to the upper fork bridge of the vehicle, in particular with the screw connection of the steering rod.

An arrangement on a lower fork bridge is of course also conceivable in principle. Preferably, the deflection device is connected to the vehicle frame in a way that prevents movement.

Preferably, the deflection device may have an adjustment device, preferably comprising an elongated hole, wherein the deflection device can be adapted to different designs and dimensions and/or areas of application by means of the adjustment device.

Particularly preferably, the deflection device may cooperate with the adjusting device comprising an elongated hole on a pivot pin of the vehicle frame and thus be mounted, wherein the relative position of the pivot pin to the deflection device can be compensated via the longitudinal extent of the elongated hole.

Preferably, the axis of rotation can be formed by a bearing pin of the support element, to which and around which the deflection device is articulated.

Preferably, the axis of rotation may coincide with a steering axis of the vehicle and/or these two axes may be aligned parallel to each other with an offset.

The follower element can have a roller which is designed and/or arranged to roll along the at least one control cam.

Preferably, the support element can be designed as a housing that at least partially encloses the control cam and is preferably designed to be sealed relative to the environment of the steering assistance device.

The housing can be designed to be fluid-and/or gas-tight.

By ensuring a tight housing design, the at least one control cam and the follower element cooperating with the at least one control cam can be protected from contamination, which could impair the functionality of the steering assistance device and/or change the steering characteristics.

The housing can be filled by a medium—preferably completely—with the tensioning element and/or the follower element being guided in the medium. A lubricant, preferably oil, can be used as the medium.

By mounting the follower element and, if applicable, also the tensioning element in the medium, preferably oil, the reaction times of these elements can be influenced. Especially when using media with low viscosities, accelerations of the elements mounted in the medium can be limited.

This has a particular advantage in that, for example, when used with off-road single-track vehicles, if sudden impacts are exerted on the steered wheel, the steering assistance device can provide resistance to these sudden impacts, wherein, for example, at high speeds and if the steered wheel hits an obstacle, such as a stone, the steering is not directly flipped or otherwise strongly rotated, but a counterforce is exerted against the obstacle, which may prevent the operator and/or driver of the single-track vehicle from falling.

Furthermore, protection is sought for a vehicle, in particular a single-track motor vehicle, with a steering assistance device according to an exemplary embodiment of the present invention.

### BRIEF DESCRIPTION OF THE DRAWINGS

Further details and advantages of the present invention will be explained in more detail below with reference to the drawings, in which:

FIG. 1 shows an exemplary embodiment of a single-track vehicle,

FIG. 2 shows the exemplary embodiment of FIG. 1 in a further perspective view,

FIG. 3 shows the exemplary embodiment of FIGS. 1 and 2 in a top view,

FIG. 4 is a detail view of FIG. 3,

FIG. 5 shows the exemplary embodiment of FIG. 3 in a deflected position,

FIG. 6 is a detail view of FIG. 5,

FIG. 7 is a side view of the exemplary embodiment of the previous figures,

FIG. 8 is a detail view of FIG. 7,

FIG. 9+10 show a representation of the acting forces of the exemplary embodiments of the preceding figures,

FIG. 11 shows a diagram regarding different steering torques for different steering curves,

FIG. 12 shows another exemplary embodiment of a steering assistance device,

FIG. 13 shows a third exemplary embodiment of a steering assistance device, and

FIG. 14 shows a fourth exemplary embodiment of a steering assistance device.

### DETAILED DESCRIPTION OF THE INVENTION

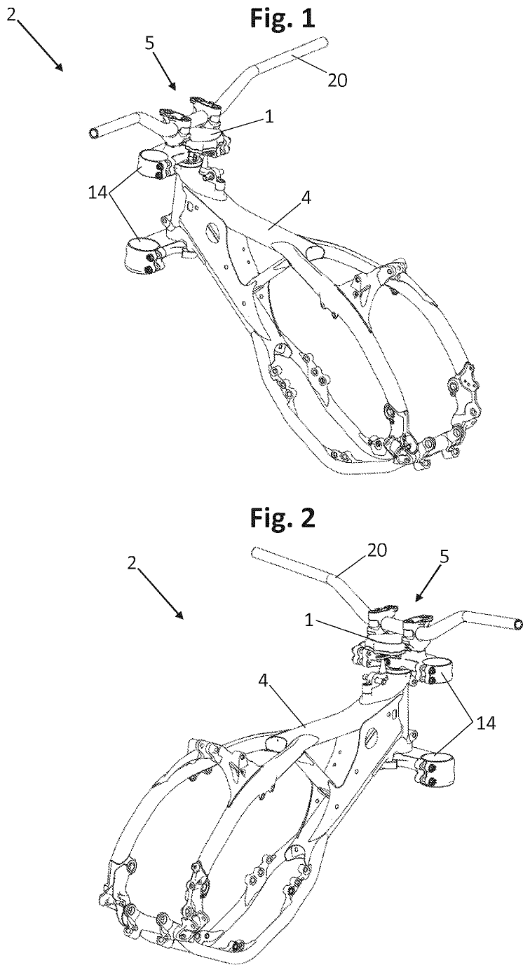

FIG. 1 shows a perspective view of an exemplary embodiment of a single-track vehicle 2. This exemplary embodiment is shown in a further perspective view in FIG. 2.

It can be seen that the single-track vehicle 2 shown in FIGS. 1 and 2 is designed as a single-track motor vehicle, with the frame 4 of the single-track vehicle and the associated steering device 5 shown in isolation to increase the clarity of the illustration.

The steering device 5 has an upper and a lower fork bridge 14, which are connected to each other via a steering tube mounted in the frame 4. The mounting of the steering tube in the frame 4 forms a steering axis for the steering device 5.

Furthermore, the handlebar 20 is mounted on the upper fork bridge 14 via a clamping device.

A steering movement can be made by an operator and/or driver of the single-track vehicle 2 via the rotational movement of the handlebar 20, wherein a rotational movement is transmitted via the steering tube and the fork bridge 14 to the fork supporting the front wheel (not shown in this exemplary embodiment for the sake of clarity).

In this exemplary embodiment, the steering assistance device 1 is positioned in the region of the upper fork bridge 14.

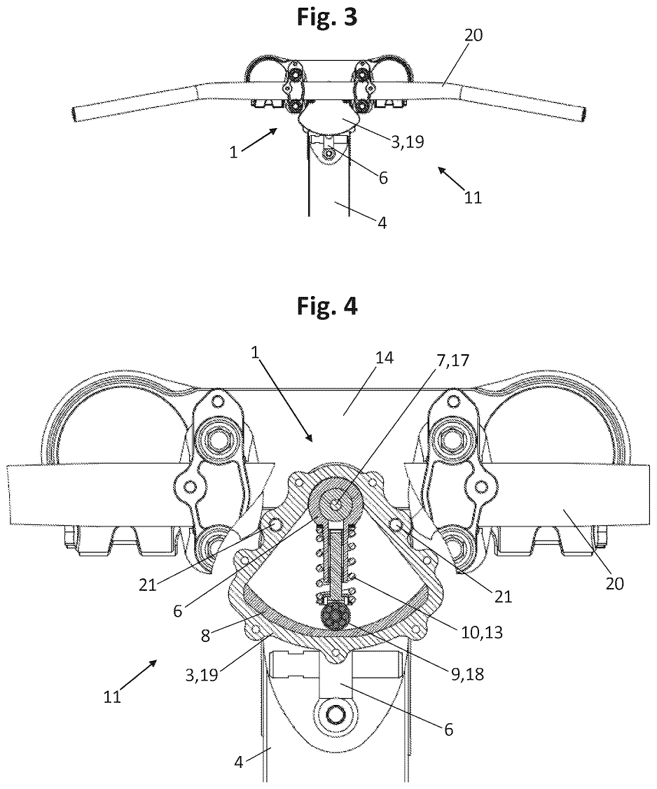

The exemplary embodiment shown in FIGS. 1 and 2 is illustrated in a top view by FIG. 3.

In the embodiment shown in FIG. 3, the steering device 5 with the handlebar 20 is in a basic position 11, in which the single-track vehicle 2 would drive straight ahead. This basic position 11 can also be considered a central position.

It can be seen that the steering assistance device 1 comprises a support device which is connected or connectable to the steering device. In this exemplary embodiment, the support element 3 is implemented as a housing 19.

Relative to the support element 3, the steering assistance device 1 comprises a movable deflection device 6, which is connected to the frame 4 of the single-track vehicle 2.

FIG. 4 shows a detailed view of FIG. 3, in which the steering assistance device 1 is shown in section. It can thus be seen that the support element 3, designed as a housing 19, is connected to the upper fork bridge 14 via the fastening points 21 in a movement-locking manner.

In this exemplary embodiment, the deflection device 6 is rotatably connected to the support element 3 and thus to the housing 19 on the bearing pin 17 of the housing 19 about the axis of rotation 7.

Furthermore, the deflection device 6 is attached to the frame 4 (reference should be made to the following figures regarding this attachment).

The control cam 8 is arranged within the housing 19 and thus within the support element 3. In this embodiment, the control cam 8 is designed as a separate component which is arranged in the housing 19. Embodiments in which the control cam is implemented as an integral part of the housing 19 are quite conceivable.

The deflection device 6 is articulated via the follower element 9 to the control cam 8. In this particular exemplary embodiment, the deflection device 6 is implemented in two parts within the housing 19, wherein a pin can insert into a plunger tube, which is pre-tensioned via the follower element 9 against the control cam 8 by means of the tensioning element 10—more precisely: the spring element 13.

In this embodiment, the follower element 9 is designed as a roller 18, which is connected to the deflection device 6 via a bearing and is designed to roll along the control cam 8.

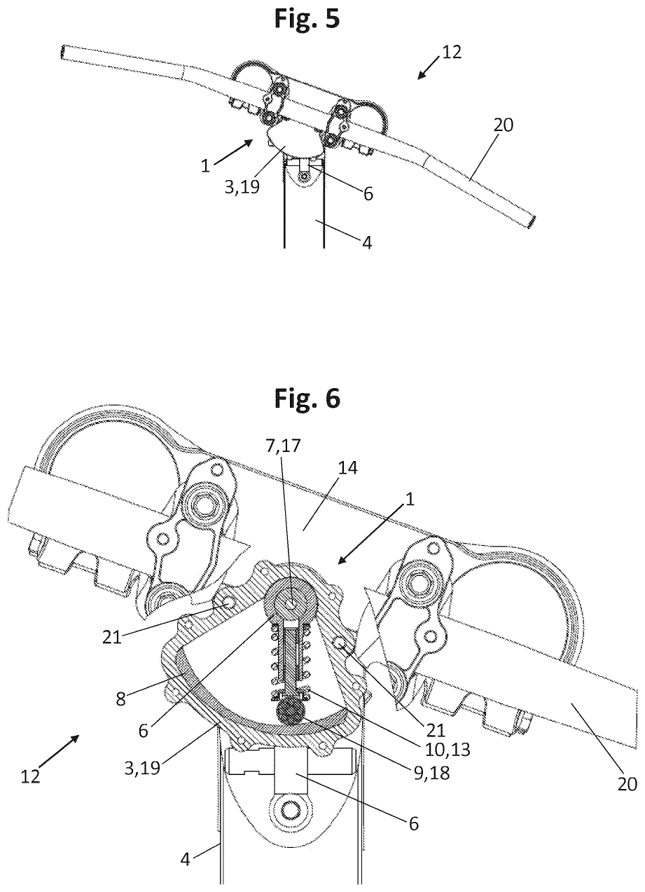

If a deflection 12 of the steering device 5 is now made via the handlebar 20 (see FIGS. 5 and 6), a relative movement is implemented between the deflection element 6 and the support element 3 (or the housing 19), wherein the follower element is moved along the control cam 8.

This movement of the follower element 9 or the roller 19 on the control cam 8 results in a distance variation between the axis of rotation 7 and the follower element 9 due to the geometric design of the control cam 8, which causes the spring element 13 to become loaded.

FIG. 5 shows the steering device 5 in a deflection 12.

FIG. 6 shows a detailed view of the steering assistance device 1 in section from FIG. 5.

By comparing FIGS. 4 and 6, it can now be seen that the deflection 12 from the basic position 11 has resulted in a change in the distance between the follower element 9 and the axis of rotation 7, which has pre-tensioned the spring element 13.

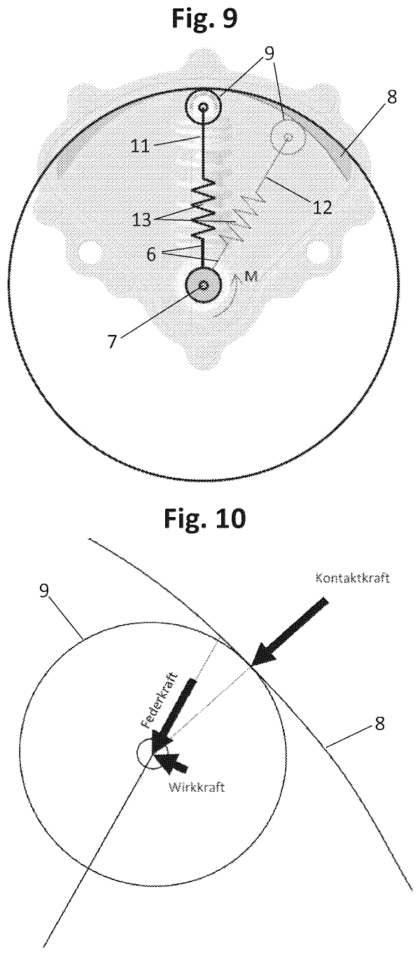

This preload creates a force between deflection device 6 and support element 3, which facilitates the return of the steering device 5 to the basic position 11 (reference is made to FIGS. 9 and 10 regarding the force progression).

This force, which facilitates the return of the handlebar 20 and thus the steering device 5 to the basic position 11, provides a driver and/or operator of the single-track vehicle 2 with a more stable driving behavior of the single-track vehicle 2, a driving behavior otherwise only provided at higher speeds of the single-track vehicle 2 by the gyroscopic forces that occur.

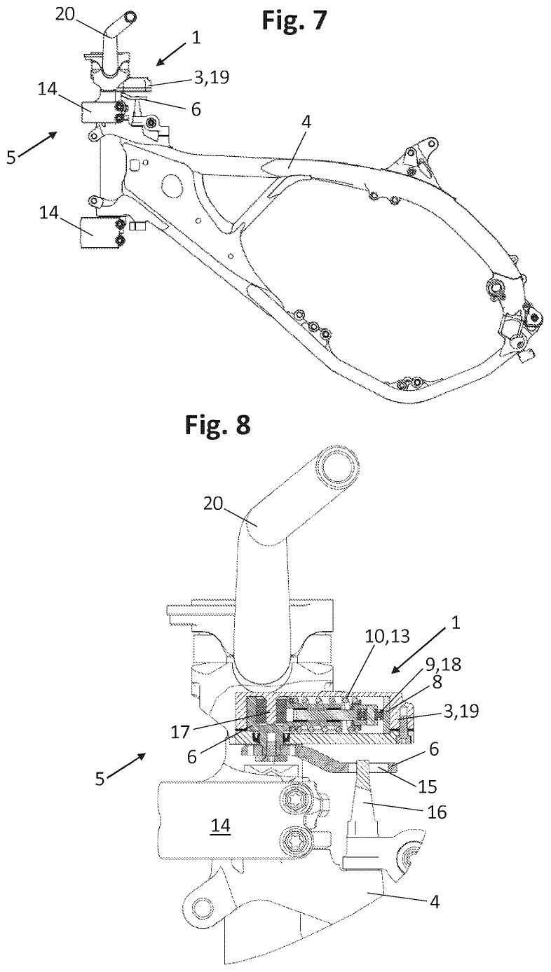

FIG. 7 shows a side view of the embodiment of the preceding claims, while FIG. 8 again shows a section detail view of the steering assistance device 1.

It can be seen in detail how the steering assistance device 1 is arranged on the single-track vehicle 2 in the region of the steering device 5.

As already known from the preceding figures, the support element 3 is attached to the fork bridge 14 via its fastening points 21 in a movement-locking manner, whereas the deflection device 6 is designed in multiple parts, as can be seen in FIG. 8.

However, these parts of the deflection device 6, which are located both inside and outside the housing 19, are connected to each other via a screw connection in a movement-locking manner.

The deflection device is rotatably arranged inside the housing 19 on the bearing pin 17 of the housing 19 and is connected to the frame 4 of the single-track vehicle 2 on the outside of the housing 19 via the pivot pin 16.

This pivot pin 16 is connected to the frame 4 in a movement-locking manner and engages in the elongated hole 15 of the deflection device 6, thereby rigidly connecting the deflection device 6 to the frame 4, whereby a relative movement of the fork bridge 14 relative to the frame 4 results in a corresponding relative movement of the deflection device 6 relative to the support element 3 (the housing 19), which moves the follower element 9 on the control cam 8, as described in the preceding figures.

By forming an elongated hole 15 on the deflection device 6, the deflection device 6 can be adapted to different designs, dimensions and/or areas of application, thereby enabling a relative displacement of the pivot pin 16 in the elongated hole 15 in order to implement this freedom.

FIGS. 9 and 10 visualize the forces acting on the steering assistance device 1 with a deflection 12.

FIG. 9 shows the schematic relationship of the individual building components and FIG. 10 shows the forces acting on the follower element 9 in detail.

It can be seen that the deflection device 6 is rotatably attached about the axis of rotation 7, with the follower element 9 being articulated to the control cam 8 and pre-tensioned against the control cam 8 via the spring element 13.

The circle shown in bold in this illustration is shown with respect to the axis of rotation 7 to show the deviation of the control cam 8 from the circle.

In FIG. 9 the deflection device 6 is shown in two positions, with the solid line representing the basic position 11 and the dotted line representing the deflection 12.

This representation thus shows that when the deflection device 6 is deflected from the basic position 11 to the deflection 12, the follower element 9 follows the control cam 8, thereby further pre-tensioning the spring element 13.

This preload results in an increased contact force at the contact point between control cam 8 and follower element 9, as can be seen in FIG. 10.

This increase in contact force is shown in FIG. 10 and can be divided into an effective force and a spring force by force decomposition.

The portion of the effective force acts—as can be seen—as a restoring force, which supports a return from the deflection 12 to the basic position 11.

As can now be seen from this exemplary embodiment, the forces and restoring forces acting due the geometric design of the control cam 8 can be freely adjusted by the geometric design of the control cam, thereby making different steering torques, which are to be exerted by an operator and/or driver of the single-track vehicle 2 when deflecting the steering device 5, freely adjustable.

It can thus be provided that the control cam 8 has at least two gradients, preferably wherein the gradient is greater at small steering angles than at large steering angles.

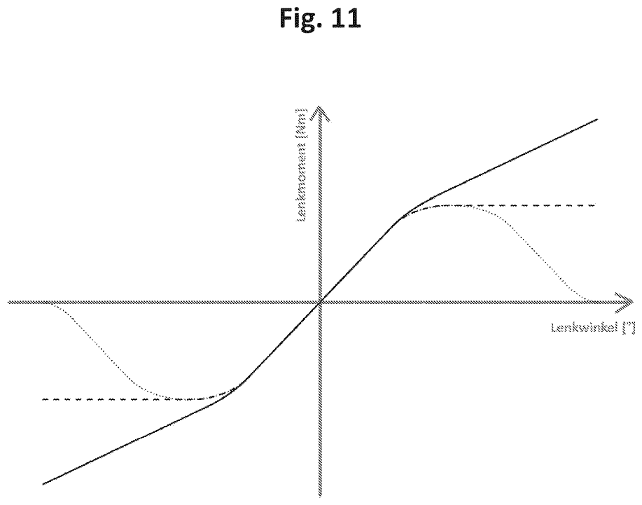

By appropriate design, the steering torque can thus be increased depending on the steering angle. Possible embodiments of different steering characteristics with respect to the steering angle are shown in the diagram of FIG. 11.

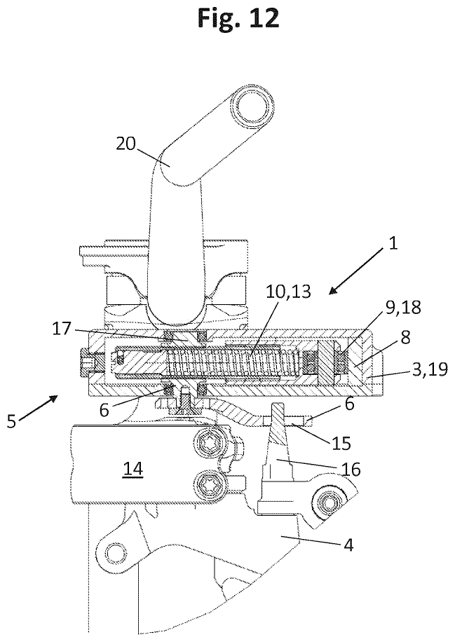

FIG. 12 shows a further exemplary embodiment of a steering assistance device 1 according to the invention, wherein—in comparison to the previous embodiment—the internal structure in the housing 19 of the steering assistance device 1 is different.

In this exemplary embodiment, the deflection device 6 is rotatably mounted relative to the support element 3 designed as a housing 19 by means of the bearing pin 17 which is formed integrally with the deflection device 6.

The bearing pin 17 engages in a corresponding recess in the housing 19 and is rotatably mounted at this point around the axis of rotation 7 by means of a bearing.

In this exemplary embodiment as well, the deflection device 6 is formed in two parts in the housing, wherein the two individual parts of the deflection device are telescopically extendable into one another and are clamped by means of a tensioning element 10—more precisely the spring element 13.

This spring element 13 in turn pre-tensions the follower element 9 (which again comprises a roller 18) attached to a part of the deflection device relative to the control cam 8.

The remaining features of the exemplary embodiments of FIG. 12 essentially correspond to those of FIGS. 1 to 11.

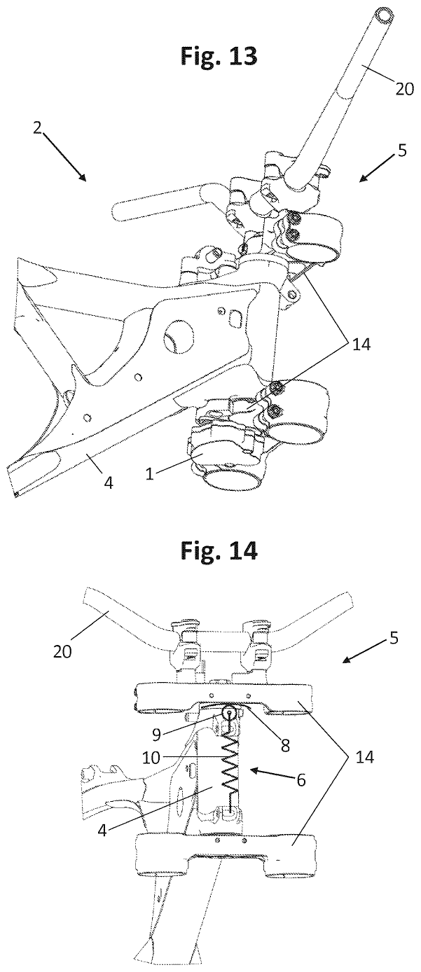

FIG. 13 shows an exemplary embodiment of an alternative positioning of the steering assistance device 1 on the single-track vehicle 2.

In this exemplary embodiment, the steering assistance device 1 is positioned on the lower fork bridge 14 of the steering device 5, wherein the support element 3 is fixedly connected to the lower fork bridge 14 and the deflection device is articulated to the frame 4.

However, an embodiment in which the support element 3 is arranged on the frame 4 and the deflection device 6 is arranged on the fork bridge 14 is also quite conceivable.

FIG. 14 shows an exemplary embodiment of a possible vertical positioning of the steering assistance device 1 on the single-track vehicle 2. This figure is to be considered purely schematic.

It has been shown that the control cam 8 can be connected to the upper fork bridge 14, for example.

The connection of the control cam to the fork bridge can be achieved, for example, via a separate support element—in particular a housing 19—or the upper fork bridge 14 itself could form the control cam 8 at least in certain regions via a corresponding geometry.

The deflection device 6 of this exemplary embodiment is connected to the frame 4, wherein the follower element 9 of the deflection device 6 is pre-tensioned relative to the control cam 8 by means of the tensioning element 10.

To optimize the characteristics of the steering assistance device 1, it may be provided that the control cam 8 has a contour rounded around the steering axis of the steering device 5.

### LIST OF REFERENCE NUMERALS

1 steering assistance device
2 vehicle
3 support element
4 frame
5 steering device
6 deflection device
7 axis of rotation
8 control cam
9 follower element
10 tensioning element
11 basic position
12 deflection
13 spring element
14 fork bridge
15 elongated hole
16 pivot pin
17 bearing pin
18 roller
19 housing
20 handlebar
21 fastening point

1. A steering assistance device for a vehicle, in particular a single-track vehicle, comprising:
a support element for mounting the steering assistance device on a frame or steering device of the vehicle, and
a deflection device, which deflection device can be articulated to the steering device or the frame, wherein the deflection device is rotatably connected to the support element about an axis of rotation,
wherein the support element has at least one control cam and the deflection device is connected to a follower element cooperating with the at least one control cam, wherein the follower element is pre-tensioned relative to the at least one control cam by means of a tensioning element.

2. The steering assistance device according to claim 1, wherein the at least one control cam is designed such that a distance between the at least one control cam and the axis of rotation in a basic position, preferably a center position, represents an extremum, wherein the distance is changed when the deflection device is deflected relative to the support element from the basic position, preferably wherein by changing the distance, the tensioning element is preloaded or further tensioned.

3. The steering assistance device according to claim 1, wherein the at least one control cam starting from the basic position is symmetrical in both directions of rotation of the support element relative to the deflection device.

4. The steering assistance device according to claim 1, wherein the at least one control cam defines a steering characteristic.

5. The steering assistance device according to claim 1, wherein the at least one control cam and/or the steering characteristic has at least two gradients, preferably wherein the gradient is greater at small steering angles than at large steering angles.

6. The steering assistance device according to claim 5, wherein the gradient is:
positive at small steering angles, and/or
positive, zero and/or negative at large steering angles.

7. The steering assistance device according to claim 1, wherein the at least one control cam is designed as an integral part of the support element or as a separate component connected to the support element.

8. The steering assistance device according to claim 1, wherein the tensioning element has a power storage device, preferably which power storage device comprises at least one spring element.

9. The steering assistance device according to claim 1, wherein the support element is connected to the steering device, preferably a steering fork, particularly preferably via a fork bridge, of the vehicle.

10. The steering assistance device according to claim 1, wherein the deflection device is connected to the frame of the vehicle in a motion-locking manner.

11. The steering assistance device according to claim 1, wherein the deflection device has an adjustment device, preferably comprising an elongated hole, wherein the deflection device can be adapted to different designs and dimensions and/or areas of application by means of the adjustment device.

12. The steering assistance device according to claim 1, wherein the axis of rotation is formed by a bearing pin of the support element, to and about which the deflection device is articulated.

13. The steering assistance device according to claim 1, wherein the follower element has a roller which is designed and/or arranged to roll on the at least one control cam.

14. The steering assistance device according to claim 1, wherein the support element can be designed as a housing that at least in regions encloses the at least one control cam and is preferably designed to be sealed relative to the environment of the steering assistance device.

15. The steering assistance device according to claim 14, wherein the housing is filled by a medium, preferably completely, wherein the tensioning element and/or the follower element is guided in the medium.

16. A vehicle, in particular a single-track motor vehicle, with a steering assistance device according to claim 1.
